(19) United States
(12) Patent Application Publication
(10) Pub. No.: US 2008/0075100 A1
(43) Pub. Date: Mar. 27, 2008

(54) METHOD FOR SETTING SUPERVISORY CONTROL LINE

(75) Inventors: Shingo TOKUNAGA, Fukuoka (JP); Junji ONO, Fukuoka (JP)

Correspondence Address: KATTEN MUCHIN ROSENMAN LLP, 575 MADISON AVENUE, NEW YORK, NY, 10022-2585, US

(73) Assignee: Fujitsu Limited, Kanagawa (JP)

(21) Appl. No.: 11/851,652

(22) Filed: Sep. 7, 2007

(30) Foreign Application Priority Data
Sep. 22, 2006 (JP) 2006-257467

(51) Int. Cl. H04L 12/28

(52) U.S. Cl. 370/410

(57) ABSTRACT

A method for setting a supervisory control circuit includes a link establish requesting process wherein a first network element transmits a link establish request to a second network element via an unused channel, and a link establish responding process wherein the second network element that receives the link establish request decides a channel for establishing a supervisory control line and transmits a link establish response to the first network element via the decided channel. The method for the setting supervisory control line further includes a connection establishing process wherein the first network element that receives the link establish response allocates the channel that transmits the link establish request as a channel for establishing the supervisory control line.

### BACKGROUND OF THE INVENTION

1. Field of the Invention

The present invention relates to a method for setting a supervisory control line between adjacent network elements and, more particularly to a method for a setting supervisory control line, capable of setting the supervisory control line without carrying out an onsite setting operation when a network element is added to a network.

2. Description of the Related Art

In a network that uses a synchronous digital transmission system, which is typically a synchronous optical network (SONET)/synchronous digital hierarchy (SDH), an open systems interconnection (OSI) network is constructed to perform a remote supervisory control of network elements that are included in the network. Setting of the network elements, collection of various alarms etc. is carried out by executing maintenance commands such as TL-1 via the OSI network.

The OSI network in the SONET/SDH network is a communication path that is used for maintaining the network elements and is not used for transmission of main signals. The OSI network is also used for downloading firmware of the network elements.

Generally, the OSI network is realized by using a data communication channel (DCC) that uses D1 to D3 bytes (192 kilobits per second (kbps)) and D4 to D12 bytes (576 kbps) inside a section overhead (SOH) of a SONET/SDH frame (for the DCC, see Japanese Patent Application Laid-open No. 2005-086619, H3-226035, and 2000-232447).

Thus, in the SONET/SDH network, although the remote supervisory control of the network elements can be carried out via the OSI network, if a new network element is added to the SONET/SDH network, an onsite setting operation is necessitated.

To be specific, after connecting a fiber cable or a coaxial cable to the new network element onsite, for enabling to carry out the supervisory control from the remote location using a network management system (NMS) that carries out central control of the network, a terminal such as a personal computer is connected to the newly added network element, the DCC is set manually, and a command needs to be given for allocating a target identification (TID) that is unique within the network.

Although an operation to connect the cable to the network element is comparatively simple, since adding the new network element necessitates the complex setting operation mentioned earlier, a network administrator needs to be present onsite when adding the new network element to the SONET/SDH network. Especially, a significant burden is put on the network administrator when adding new network elements in a plurality of positions.

### SUMMARY OF THE INVENTION

It is an object of the present invention to at least partially solve the problems in the conventional technology.

According to an aspect of the present invention, there is provided a method for automatically setting a supervisory control line between a first network element and a second network element, includes transmitting a link establish request by the first network element to the second network element; deciding, by the second network element that receives the link establish request, a channel for establishing the supervisory control line between the second network element and the first network element; transmitting a link establish response to the first network element via the channel; and allocating, by the first network element that receives the link establish response, the channel that transmits the link establish request as a channel for establishing the supervisory control line between the first network element and the second network element.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of an example of a network structure;

FIG. 2 is a block diagram of a network element;

FIG. 3 is a block diagram of a network management system;

FIG. 4 is a flowchart of automatic setting of a DCC line;

FIGS. 5A to 5D are schematics of an example of a DCC management table of a network element 100A;

FIGS. 6A to 6D are schematics of an example of a DCC management table of a network element 100E;

FIG. 7 is a schematic of an NSAP address format;

FIG. 8 is a schematic of a format of a link establish request;

FIG. 9 is a schematic of a format of a link establish response;

FIG. 10 is a schematic of a format of a connection ID notification;

FIG. 11 is a schematic of a format of a connection ID notification response;

FIG. 12 is a schematic of another example of the network structure;

FIG. 13 is a schematic of a format of a set TID request;

FIG. 14 is a schematic of an example of a TARP cache;

FIG. 15 is a schematic of a format of a TID setting error response;

FIG. 16 is a schematic of yet another example of the network structure;

FIG. 17 is a schematic of a format of a generate TID request; and

FIG. 18 is a schematic of a format of a TID generation response.

### DETAILED DESCRIPTION OF THE PREFERRED EMBODIMENTS

Exemplary embodiments of the present invention are explained below with reference to the accompanying drawings.

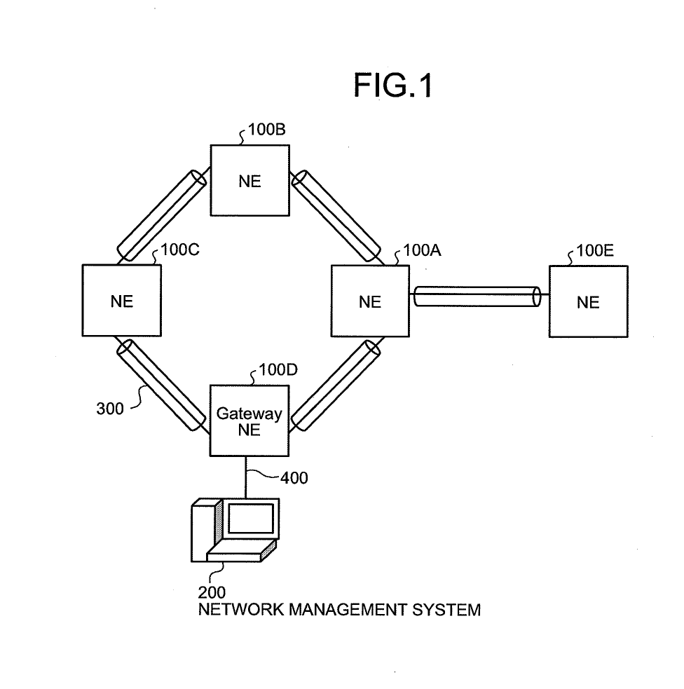

A network structure of a synchronous optical network/synchronous digital hierarchy (SONET/SDH) network is explained first. FIG. 1 is a schematic of an example of the network structure of the SONET/SDH network. As shown in FIG. 1, the SONET/SDH network includes network elements (NE) 100A to 100E that are connected by optical fiber cables 300 such as OC-3.

A network management system 200 which carries out a supervisory control of the entire network is connected to the network element 100D using a local area network (LAN) 400. Serial cables can also be used to connect the network management system 200 to the network element 100D. A network element such as the network element 100D, which is connected to the network management system 200, is called a gateway NE.

A unique target identification (TID) is prior set in all the network elements that are included in the network. By specifying the TID from the network management system 200 and using TL-1 to log in, a network administrator can set a cross connection of the network element indicated by the TID and can collect alarms etc. that are occurring.

A data communication channel (DCC) line, which is used for carrying out a remote execution of TL-1, is realized by using D byte data of an overhead portion of a frame that is transmitted via the optical fiber cables 300 that connect the network elements. Sine a maintenance command such as TL-1 etc. is transmitted via the DCC line, an initialization of the DCC line cannot be remotely executed using TL-1.

A structure of the network elements 100A to 100E shown in FIG. 1 is explained next. Since the network elements 100A to 100E include a similar structure, an example of the network element 100A is used to explain the structure.

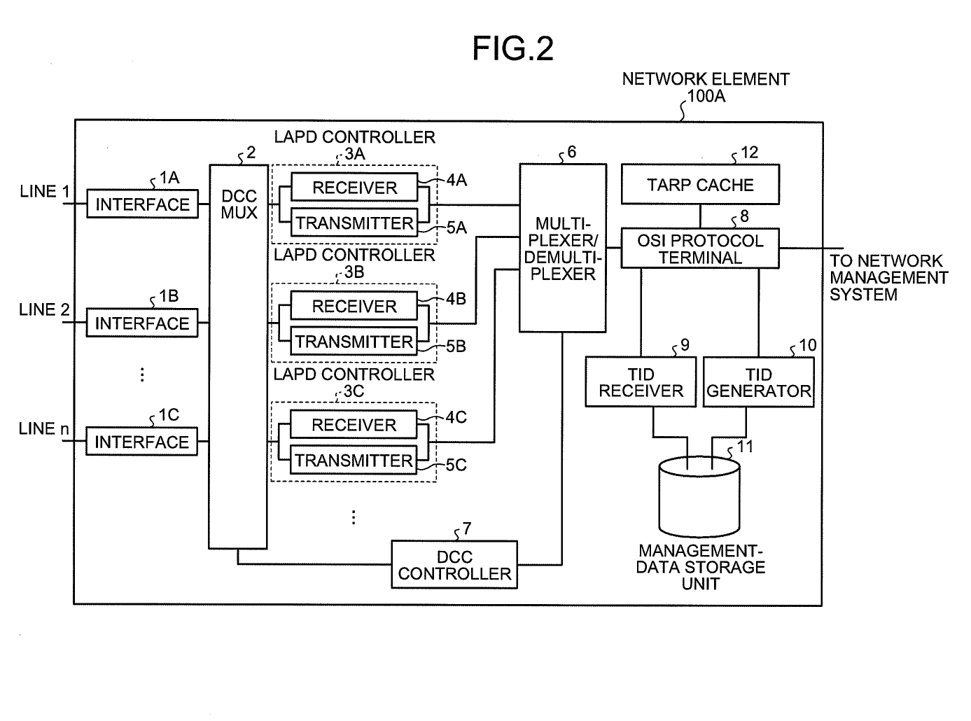

FIG. 2 is a block diagram of the network element 100A. As shown in FIG. 2, the network element 100A includes interfaces 1A to 1C, a DCC multiplexer (DCC MUX) 2, link access procedure on the D-channel (LAPD) controllers 3A to 3C, a multiplexer/demultiplexer 6, a DCC controller 7, an OSI protocol terminal 8, a TID receiver 9, a TID generator 10, a management-data storage unit 11, and a Tid address resolution protocol (TARP) cache 12. For the sake of convenience, components other than components that are related to setting of the DCC line are not shown in FIG. 2.

The interfaces 1A to 1C terminate the cables of the SONET/SDH network. After separating a payload portion and an overhead portion of SONET/SDH signals, the interfaces 1A to 1C transmit to the DCC MUX 2, the D byte data that is included in the overhead portion. According to an instruction from the DCC controller 7, the DCC MUX 2 connects the interfaces 1A to 1C with the LAPD controllers 3A to 3C.

The LAPD controllers 3A to 3C terminate an LAPD protocol that is a data link layer protocol of the DCC. The LAPD controller 3A includes a receiver 4A and a transmitter 5A. The LAPD controller 3B includes a receiver 4B and a transmitter 5B. The LAPD controller 3C includes a receiver 4C and a transmitter 5C.

Apart from receiving general LAPD signals, the receivers 4A to 4C receive and monitor a transmission, from the adjacent network element, of a later explained link establish request and a connection ID notification. Apart from transmitting the general LAPD signals, the transmitters 5A to 5C transmit the link establish request and the connection ID notification.

In the embodiments explained below, when not specifying any one of the interfaces 1A to 1C, the interfaces 1A to 1C are referred to as the interfaces 1. Similarly, the LAPD controllers 3A to 3C, the receivers 4A to 4C, and the transmitters 5A to 5C are referred to as the LAPD controllers 3, the receivers 4, and the transmitters 5 respectively when any one of the LAPD controllers 3A to 3C, the receivers 4A to 4C, and the transmitters 5A to 5C are not specified. Further, although three interfaces 1 and three LAPD controllers 3 are used in the example shown in FIG. 2, the number of the interfaces and the LAPD controllers need not be three, and the number of the interfaces need not be the same as the number of the LAPD controllers.

If multiple DCC lines are set between the adjacent network elements, the multiplexer/demultiplexer 6 carries out multiplexing and demultiplexing of the LAPD signals. To be specific, if the receivers 4 receive the LAPD signals that are transmitted from the adjacent network element that is connected by the multiple set DCC lines, the multiplexer/demultiplexer 6 rearranges the signals in an initial sequence and carries out multiplexing of the signals. Further, if the OSI protocol terminal 8 transmits the signals to the adjacent network element that is connected by the multiple set DCC lines, the multiplexer/demultiplexer 6 carries out demultiplexing of the signals and transmits the demultiplexed signals to the transmitters 5 that are connected to the respective DCC lines.

Based on a receiving status of the link establish request in the receivers 4, the DCC controller 7 transmits connection switching signals to the DCC MUX 2. Further, the DCC controller 7 retrieves data of the connection ID notifications that are received by the receivers 4, and if the receivers 4 have received the same connection ID notification, the DCC controller 7 instructs the multiplexer/demultiplexer 6 to carry out multiplexing and demultiplexing for them. The OSI protocol terminal 8 terminates an OSI protocol that is located above the LAPD protocol and provides application services such as the TL-1 command.

Among the signals that are received by the OSI protocol terminal 8, the TID receiver 9 terminates a later explained set TID request, stores the TID extracted from the set TID request in the management-data storage unit 11, and sets the stored TID as the TID of the network element 100A itself. The TID generator 10 generates the TID that is set in the network element 100A itself or the TID that is set in the adjacent network element, and transmits the generated TID to the OSI protocol terminal 8 for further transmitting the TID to the network management system 200 or to the adjacent network element.

The management-data storage unit 11 stores therein various types of management data such as the TID that are set in the network elements. The TARP cache 12 stores therein a correspondence between network service access point (NSAP) addresses that are unique values assigned to the network elements affiliated to the OSI network and the TID.

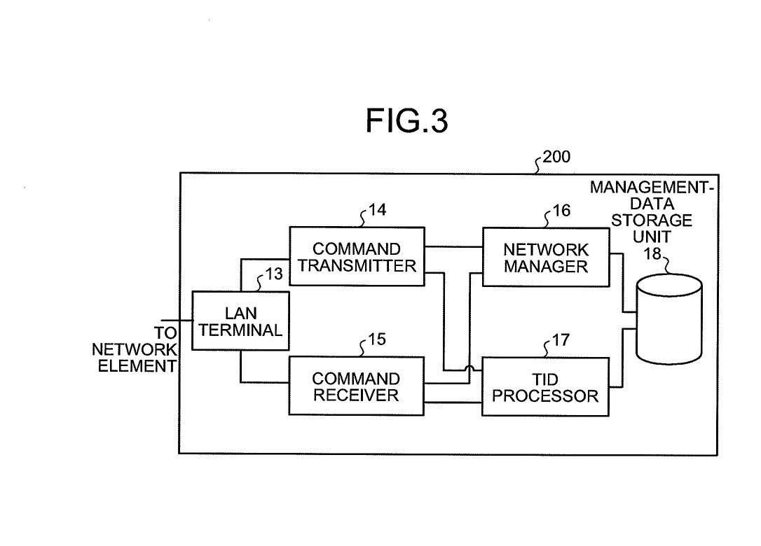

A structure of the network management system 200 shown in FIG. 1 is explained next. FIG. 3 is a block diagram of the network management system 200. As shown in FIG. 3, the network management system 200 includes a LAN terminal 13, a command transmitter 14, a command receiver 15, a network manager 16, a TID processor 17, and a management-data storage unit 18.

The LAN terminal 13 provides an interface between the OSI protocol terminals 8 of the network elements and the network management system 200. The command transmitter 14 generates commands and control packets that are necessary for setting the network elements. The command receiver 15 receives and analyzes the control packets that include the commands that are transmitted from the network elements.

The network manager 16 provides commonly used network control functions such as displaying the network structure on a screen etc. The TID processor 17 provides functions such as automatically generating the TID that are allocated to the network elements and storing in the management-data storage unit 18, the TID that are notified from the network elements. The management-data storage unit 18 stores therein various types of data that needs to be stored by the network management system 200.

Next, in the network shown in FIG. 1, an automatic setting of the DCC line is explained assuming that the network element 100E is newly connected to the network element 100A that is already connected to the network.

Further, it is prior assumed that the interface 1A of the network element 100A and the interface 1A of the network element 100E are already connected by using the optical fiber cables such as OC-3 or fiber cables such as EC-1. Similarly, the interface 1B of the network element 100A and the interface 1B of the network element 100E are already connected by using the optical fiber cables such as OC-3 or the fiber cables such as EC-1.

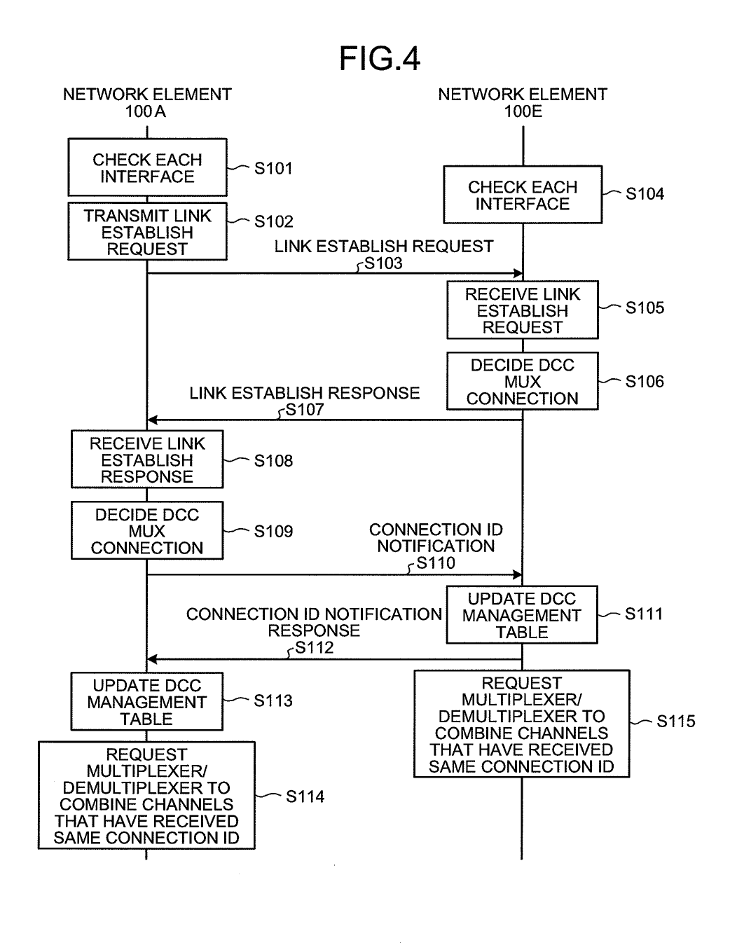

FIG. 4 is a flowchart of the automatic setting of the DCC line. The DCC controller 7 of the network element 100A periodically monitors the interfaces 1 and confirms whether a cable is newly connected to the interfaces 1. It is assumed that the DCC controller 7 detects that a new cable is connected to the interface 1A (step S101).

Upon detecting that a cable is newly connected to the interface 1A, for setting the DCC line via the cable that is connected to the interface 1A, the DCC controller 7 first refers to a DCC management table that is stored in the management-data storage unit 11 and searches for an unused channel of the LAPD controllers 3.

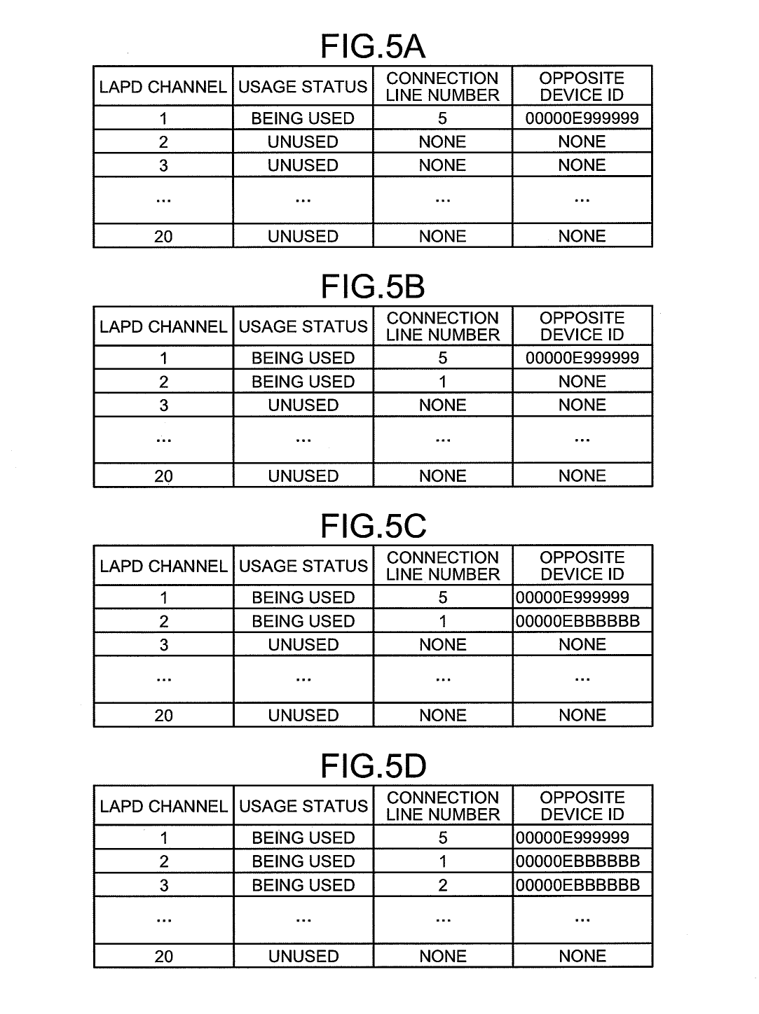

An example of the DCC management table is shown in FIG. 5A. The DCC management table is a table for managing a setting status of the DCC line for each LAPD channel. The DCC management table includes entries of an LAPD channel, a usage status, a connection line number, and an opposite device ID.

A number for identifying the LAPD channel is set in the entry of the LAPD channel. The LAPD channels correspond one to one with the LAPD controllers 3. For example, a channel 1 corresponds to the LAPD controller 3A, a channel 2 corresponds to the LAPD controller 3B, and a channel 3 corresponds to the LAPD controller 3C.

Whether the LAPD channel is being used for setting the DCC line is set in the entry of the usage status. A number, which identifies the cable (line) having the set DCC line, is set in the entry of the connection line number. The connection line numbers correspond one to one with the interfaces 1. For example, a line 1 corresponds to the cable connected to the interface 1A, a line 2 corresponds to the cable connected to the interface 1B, and a line 3 corresponds to the cable connected to the interface 1C.

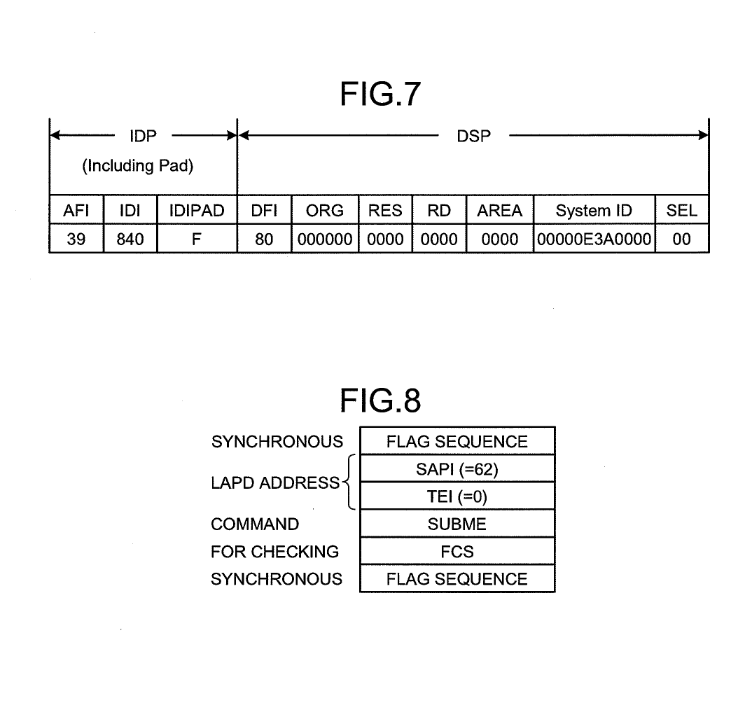

A device ID for identifying the network element opposite the DCC line is set in the entry of the opposite device ID. The device ID needs to be unique within the network. For example, System ID field (6 bytes) of the NSAP address shown in FIG. 7 can be used as the device ID. A different value of the System ID field for each network element is guaranteed. Note that the abbreviations shown in FIG. 7 are as follows:

IDP: Initial Domain Part

DSP: Domain Specific Part

AFI: Authority and Format Identifier

IDI: Initial Domain Identifier

DFI: DSP Format, Identifier

ORG: Organization

RES: Reserved

RD: Routing Domain

AREA: Identifier for a Routing Area within Routing Domain

System ID: Routing Entity Identifier for routing entity within a NE or OS

SEL: NSAP Selector

If the DCC management table is as shown in FIG. 5A, since the channel 1 is already being used, the DCC controller 7 selects the channel 2 as an unused LAPD channel. Next, the DCC controller 7 instructs the DCC MUX 2 to connect the LAPD controller 3B corresponding to the selected channel 2 to the interface 1A in which a new wire connection is detected. Further, since a response from the network element 100E is awaited, a connection between the LAPD controller 3B and the interface 1A is maintained for a sufficient time period that is necessitated.

After connecting the LAPD controller 3B to the interface 1A, as shown in FIG. 8, the DCC controller 7 instructs the transmitter 5B of the LAPD controller 3B to transmit a link establish request (step S102).

Due to this, the transmitter 5B inside the LAPD controller 3B transmits to the interface 1A of the newly included network element 100E, the link establish request via the DCC MUX 2 and the interface 1A. If a response to the link establish request is not received even after lapse of a predetermined time period, the DCC controller 7 retransmits the link establish request (step S103).

Similarly, upon detecting that a new cable is connected to the interface 1A, the DCC controller 7 of the network element 100E executes a process for transmitting the link establish request from the interface 1A (step S104). It is assumed that before the network element 100E transmits the link establish request, the link establish request transmitted from the network element 100A is received by the network element 100E.

Since the interface 1A of the network element 100A is connected to the interface 1A of the network element 100E, the link establish request transmitted by the network element 100A is received in the interface 1A of the network element 100E. The received link establish request is transferred by the DCC MUX 2 to any one of the unused receivers 4 and the content of the link establish request is notified to the DCC controller 7 (step S105).

Upon receiving a notification that the link establish request is received in the interface 1A, the DCC controller 7 refers to the DCC management table stored in the management-data storage unit 11 and searches for an unused channel of the LAPD controllers 3.

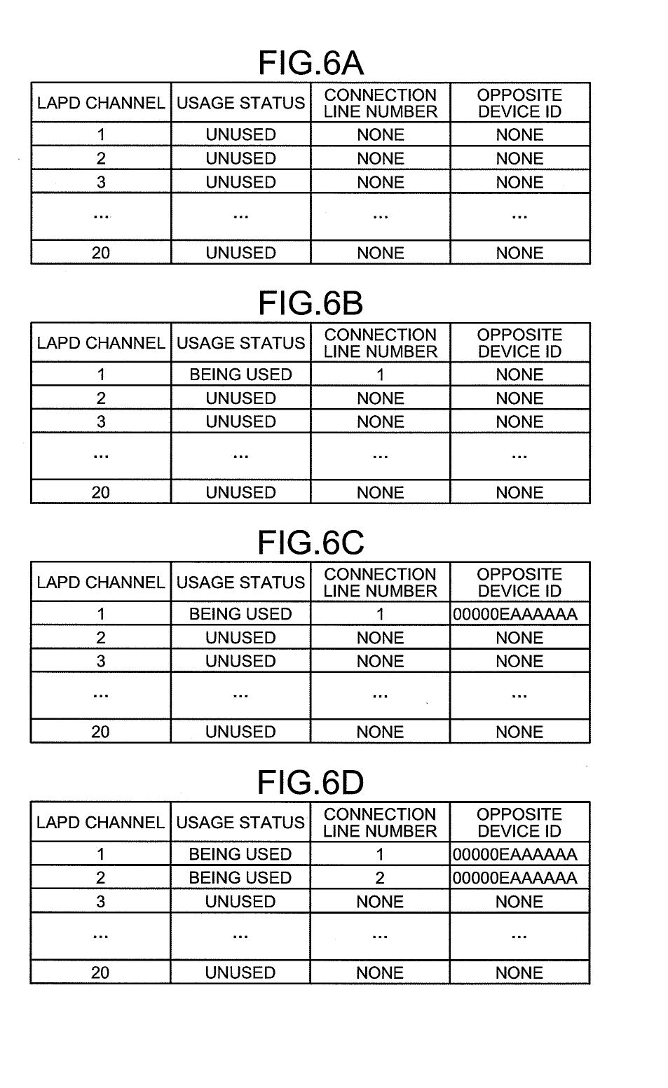

If the DCC management table is as shown in FIG. 6A, since any channel of the LAPD controllers 3 is not being used, the DCC controller 7 selects the channel 1 as the unused LAPD channel. Next, the DCC controller 7 instructs the DCC MUX 2 to connect the LAPD controller 3A corresponding to the selected channel 1 to the interface 1A that has received the link establish request. As shown in FIG. 6B, the DCC controller 7 updates the DCC management table and records an entry to the effect that the channel 1 is being used and is connected to the interface 1A (step S106).

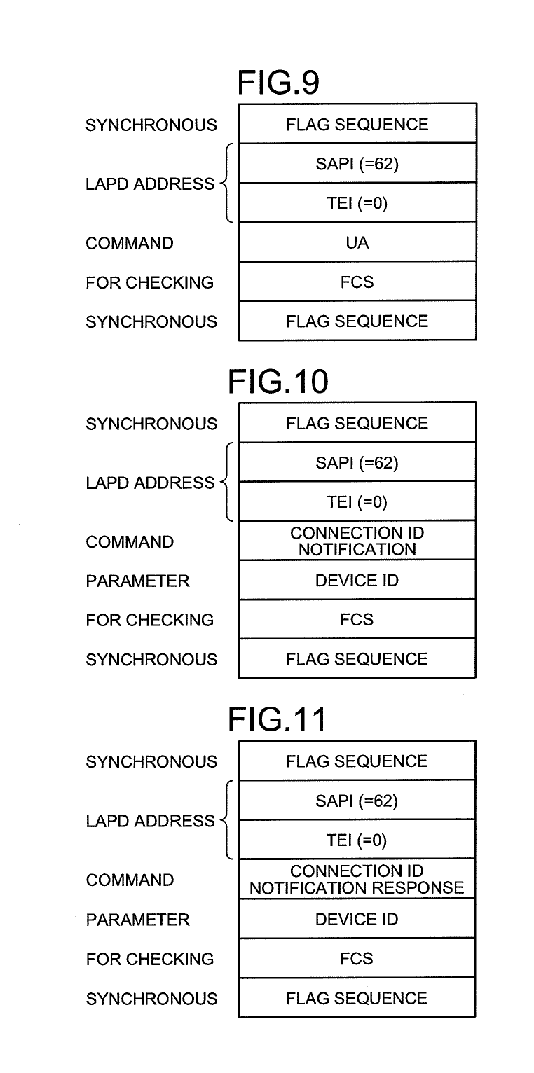

After connecting the LAPD controller 3A to the interface 1A, the DCC controller 7 instructs the transmitter 5A of the LAPD controller 3A to transmit a link establish response that is shown in FIG. 9. Due to this, the transmitter 5A inside the LAPD controller 3A transmits to the interface 1A of the network element 100A, the link establish response via the DCC MUX 2 and the interface 1A (step S107).

Upon receiving a notification to the effect that the link establish response is received in the interface 1A (step S108), the DCC controller 7 of the network element 100A instructs the DCC MUX 2 to fix the connection between the interface 1A that has received the link establish response and the LAPD controller 3B. Further, as shown in FIG. 5B, the DCC controller 7 updates the DCC management table and records an entry to the effect that the channel 2 is being used and is connected to the interface 1A (step S109).

Next, the DCC controller 7 of the network element 100A notifies the device ID of the network element 100A to the transmitter 5B inside the LAPD controller 3B and as shown in FIG. 10, and causes the transmitter 5B to transmit the connection ID notification that includes the embedded device ID. The transmitter 5B transmits the connection ID notification to the opposite network element 100E via the DCC MUX 2 and the interface 1A (step S110).

The receiver 4A of the network element 100E receives the connection ID notification and notifies the content of the connection ID notification to the DCC controller 7. The DCC controller 7 extracts the transmitted device ID, and stores the extracted device ID in the DCC management table as the opposite device ID of the DCC line set in the channel 1 that has received the connection ID notification. Due to this, the DCC management table of the network element 100E is updated as shown in FIG. 6C (step S111).

Next, the DCC controller 7 of the network element 100E notifies the device ID of the network element 100E to the transmitter 5A inside the LAPD controller 3A, and as shown in FIG. 11, causes the transmitter 5A to transmit a connection ID notification response that includes the embedded device ID. The transmitter 5A transmits the connection ID notification response to the opposite network element 100A via the DCC MUX 2 and the interface 1A (step S112).

The receiver 4B of the network element 100A receives the connection ID notification response and notifies the content of the connection ID notification response to the DCC controller 7. The DCC controller 7 extracts the transmitted device ID and stores the extracted device ID in the DCC management table as the opposite device ID of the DCC line set in the channel 2 that has received the connection ID notification response. Due to this, the DCC management table of the network element 100A is updated as shown in FIG. 5C (step S113).

A string of the operation mentioned earlier is also carried out between the interface 1B of the network element 100A and the interface 1B of the network element 100E and two DCC lines are established between the network element 100A and the network element 100E. Due to this, the DCC management table of the network element 100A is updated as shown in FIG. 5D and the DCC management table of the network element 100E is updated as shown in FIG. 6D.

The DCC controller 7 of the network element 100A refers to the DCC management table after update, confirms that the opposite network element connected to both the LAPD controllers 3B and 3C is the network element 100E, and notifies the multiplexer/demultiplexer 6 to combine and use the two channels (step S114).

The DCC controller 7 of the network element 100E refers to the DCC management table after update, confirms that the opposite network element connected to both the LAPD controllers 3B and 3C is the network element 100A, and notifies the multiplexer/demultiplexer 6 to combine and use the two channels (step S115).

Next, when transmitting packets to the two channels, the multiplexer/demultiplexers 6 of the network elements 100A and 100E operate such that the two channels are alternately used to transmit LAPD packets. When receiving packets from the two channels, the multiplexer/demultiplexers 6 refer to sequence numbers, included inside the LAPD packets that are received, arrange the LAPD packets according to a numerical order, and notify the OSI protocol terminals 8.

In the first embodiment, the DCC line is automatically established by automatically exchanging messages between the newly added network element and the adjacent network element. Due to this, necessity of an onsite setting operation to directly connect a terminal to the network element is removed, thus reducing the burden on a network administrator.

Further, in the first embodiment, even if multiple DCC lines are set between the adjacent network elements, the multiple DCC lines are secured and used as a single DCC line. Thus, a high-speed and highly reliable DCC line can be set.

In the example explained earlier, the link establish request is transmitted from the network element 100A to the network element 100E. However, similar effects can be obtained even when the link establish request is transmitted from the network element 100E to the network element 100A.

Further, in the example explained earlier, when a new cable is connected, the DCC controller 7 of the network element 1010A or the network element 100E autonomously transmits the link establish request. However, the network administrator can also operate the network management system 200 to issue an instruction to the network element 100A that is already connected to the OSI network, and upon receiving the instruction, the DCC controller 7 of the network element 100A can transmit the link establish request.

In addition to establishing the DCC line, a unique TID needs to be allocated to each network element for issuing the maintenance command to the network elements from the network management system 200. However, in many instances, a manufacturer specific fixed value is set as an initial TID. The initial TID is highly likely to overlap with the TID of the other network elements.

To overcome the drawback, a method, which automatically allocates a unique TID to the network element that is added to the network, is explained in a second embodiment of the present invention.

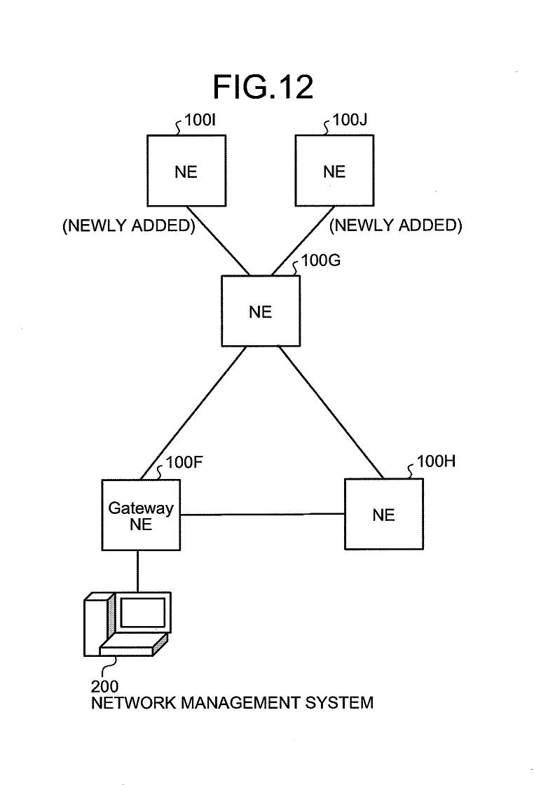

An example of the network, which is used to explain the second embodiment, is shown in FIG. 12. Network elements 100F to 100J, which include a structure similar to the structure of the network element 100A shown in FIG. 2, are connected to form the network shown in FIG. 12. The network management system 200, which carries out the supervisory control of the entire network, is connected to the network element 100F.

In the network shown in FIG. 12, automatic allocation of the TID is explained by assuming that the network element 100I is newly connected to the network element 100G that is already connected to the network. Further, it is prior assumed that the network element 100G and the network element 100I are already connected by using the optical fiber cables such as OC-3 or the fiber cables such as EC-1 and establishment of the DCC line is completed.

An NSAP address similar to the NSAP address as shown in FIG. 7 is stored in the management-data storage unit 11 of the network element 100I. A value, which is unique to all the network elements that terminate the OSI protocol, is allocated to the System ID portion of the NSAP address. After establishing the DCC line, the TID generator 10 of the newly added network element 100I retrieves the System ID from the management-data storage unit 11, and converts the retrieved System ID into a character string in the form of a hexadecimal expression to generate the unique TID. The TID generator 10 stores the generated TID in the management-data storage unit 11 as the TID of the network element 100I and notifies the generated TID to the OSI protocol terminal 8.

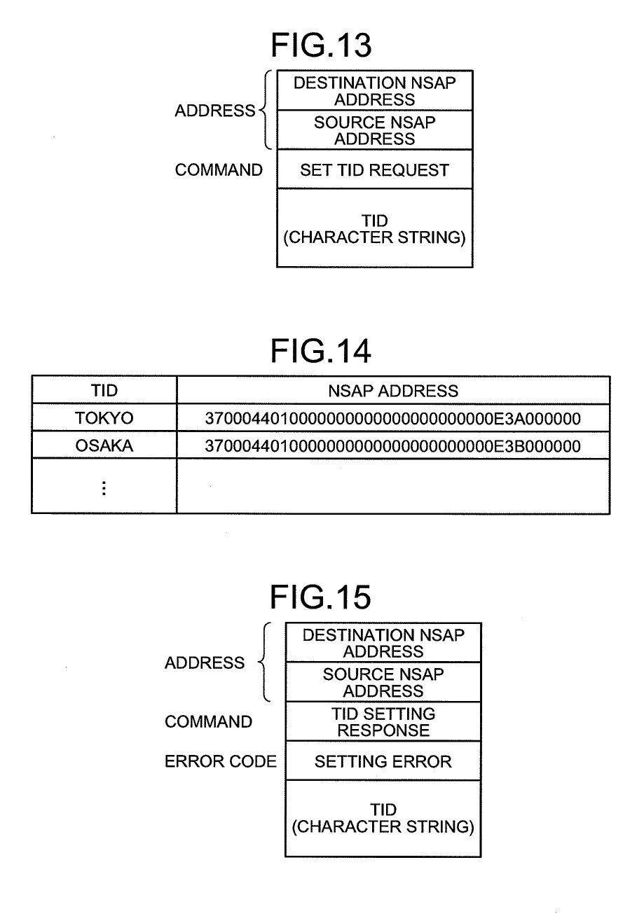

The OSI protocol terminal 8 embeds the notified TID to generate a set TID request shown in FIG. 13, and transmits the generated set TID request to the adjacent network element 100G via the DCC line.

The NSAP address of the network element 100F which is the gateway NE is prior recorded in the management-data storage unit 11 of the network element 100G. After receiving the set TID request, the OSI protocol terminal 8 of the network element 100G rewrites the NSAP address of the network element 100F as a destination NSAP address and transfers the set TID request.

Upon receiving the set TID request, the network element 100F transfers the set TID request to the network management system 200 via the OSI protocol terminal 8. The set TID request received by the network management system 200 is notified to the TID processor 17 via the LAN terminal 13 and the command receiver 15. The TID processor 17 recognizes the TID of the newly added network element 100I and stores the TID in the management-data storage unit 18.

After the network management system 200 has recognized the TID, command operations which use the TID of the network element 100I specified from the network management system 200 are enabled.

Since the TID which is allocated to the network element 100I using the operation mentioned earlier is generated based on the System ID, the TID is meaningless to human beings and a user may not like to continue using the TID. Since the network management system 200 can already execute the maintenance command on the network element 100I, the user can use the TL-1 command (SET-SID) that modifies the TID of the network elements and modify the TID of the network element 100I to a random value.

In the second embodiment, the TID is generated based on the System ID that is guaranteed to be unique and the generated TID is notified to the network management system 200 via the adjacent network element. Thus, the unique TID can be automatically allocated to the newly added network element.

In the second embodiment, the TID is generated based on the System ID. However, the TID can also be generated based on an ID other than the System ID if the ID is guaranteed to be unique.

Generation of the TID by the newly added network element itself is explained in the second embodiment. However, the network management system 200 can also be used to generate the TID. In an operation explained in a third embodiment of the present invention, in the network shown in FIG. 12, it is assumed that the network elements 100I and 100J are newly added to the network element 100G that is already connected to the network. Generation of the TID and allocation of the generated TID to the newly added network elements by the network management system 200 is explained.

Further, it is prior assumed that the network elements 100G and 100I and the network elements 100G and 100J are already connected by using the optical fiber cables such as OC-3 or the fiber cables such as EC-1 and establishment of the DCC line is completed. Further it is assumed that “FUJITSU” is allocated to the network elements 100I and 100J as the initial TID at the time of manufacturing.

Upon detecting that a new DCC line is established, the TID processor 17 of the network management system 200 accesses the management-data storage unit 18 and generates a TID that does not overlap with the already existing TID. The TID can be generated by using a random number or a meaningful character string can also be generated as the TID as in a method in which words in a prior recorded list are extracted one by one and a word that does not match with the already existing TID is picked as the TID.

Next, the TID processor 17 uses “FUJITSU” as the destination TID to generate the set TID request that is shown in FIG. 13. The generated set TID request is notified to the OSI protocol terminal 8 of the network element 100F via the command transmitter 14 and the LAN terminal 13.

The OSI protocol terminal 8 refers to the TARP cache 12 and confirms whether the NSAP address of TID=FUJITSU is recorded. As shown in FIG. 14, the TARP cache 12 is a table that stores therein a correspondence between the TID and the NSAP address.

The TARP cache 12 of the network element 100F does not include an entry of TID=FUJITSU immediately after addition of the network elements 100I and 100J. Due to this, the OSI protocol terminal 8 generates a TARP request for checking the NSAP address of the network element that includes “FUJITSU” as the allocated TID, and transmits the generated TARP request to the adjacent network elements 100G and 100H.

Upon receiving the TARP request, the network element 100G notifies the TARP request to the OSI protocol terminal 8. The OSI protocol terminal 8 refers to the TARP cache 12 and checks whether the entry of TID=FUJITSU exists. Since the TARP cache 12 does not include the entry of TID=FUJITSU, the OSI protocol terminal 8 transfers the TARP request to the adjacent network elements 100I, 100J, and 100H.

Thus, the network elements 100I and 100J receive the TARP request nearly simultaneously. The TARP request is notified to the respective OSI protocol terminals 8 and is compared to the TID of the respective network element itself. Since the TID included in the TARP request matches with the TID of the respective network element itself, the network elements 100I and 100J return a TARP response to the network element 100G. The NSAP addresses of the respective network elements are embedded in the TARP responses.

It is assumed that the network element 100G receives the TARP response from the network element 100I before receiving the TARP response from the network element 100J. Upon receiving the TARP response, the OSI protocol terminal 8 of the network element 100G creates the entry of TID=FUJITSU in the TARP cache 12, and sets the NSAP address of the network element 100I in the created entry. Next, the OSI protocol terminal 8 transfers the TARP response to the network element 100F.

Next, the network element 100G also receives the TARP response from the network element 100J. However, since the entry of TID=FUJITSU already exists in the TARP cache 12, the network element 100G discards the received TARP response.

Similarly as the OSI protocol terminal 8 of the network element 100G, upon receiving the TARP response, the OSI protocol terminal 8 of the network element 100F creates the entry of TID=FUJITSU in the TARP cache 12. Using a string of the operation mentioned earlier, the network element 100F can grasp the NSAP address of the newly included network element 100I and the network element 100I can be operated from the network management system 200 that is connected to the network element 100F.

The TID processor 17 of the network management system 200 modifies the TID of the network element 100I to the already generated unique TID and ends the automatic allocation of the TID to the network element 100I.

Next, the TID processor 17 of the network management system 200 generates another unique ID for the network element connected to another DCC line that is detected as newly established. For modifying the TID of the network element connected to the other DCC line, the TID processor 17 generates a set TID request using destination TID=FUJITSU.

The generated set TID request is notified to the OSI protocol terminal 8 of the network element 100F. The OSI protocol terminal 8 refers to the TARP cache 12 and confirms whether the NSAP address of TID=FUJITSU is recorded. Due to the operation mentioned earlier, since the NSAP address of the network element 100I is recorded as the NSAP address of TID=FUJITSU, the OSI protocol terminal 8 sets the NSAP address of the network element 100I as the destination address, and transmits the set TID request to the network element 100I.

The OSI protocol terminal 8 of the network element 100I receives the set TID request. However, since the TID of the network element 100I is already modified to another value from FUJITSU, the OSI protocol terminal 8 returns to the network element 100G, a TID setting error response that is shown in FIG. 15.

The OSI protocol terminal 8 of the network element 100G receives the TID setting error response, recognizes that the entry of TID=FUJITSU is invalid, deletes the entry of TID=FUJITSU from the TARP cache 12, and transfers the TID setting error response to the network element 100F.

The OSI protocol terminal 8 of the network element 100F also receives the TID setting error response, recognizes that the entry of TID=FUJITSU is invalid, and deletes the entry of TID=FUJITSU from the TARP cache 12. For grasping the NSAP address of the network element having TID=FUJITSU, the OSI protocol terminal 8 transmits the TARP request to the adjacent network elements 100G and 100H.

The automatic setting operation of the TID that is carried out among the network management system 200, the network element 100F, and the network element 100I mentioned earlier is similarly carried out among the network management-system 200, the network element 100F, and the network element 100J and the TID of the network element 100J is modified to a unique value.

In the third embodiment, the network management system 200, which recognizes the TID of all the network elements, generates a unique TID and sets the generated TID in the newly added network elements. Thus, the unique TID can be automatically allocated to the newly added network elements.

Generation of the TID in the newly added network element by an adjacent network element is explained in a fourth embodiment of the present invention.

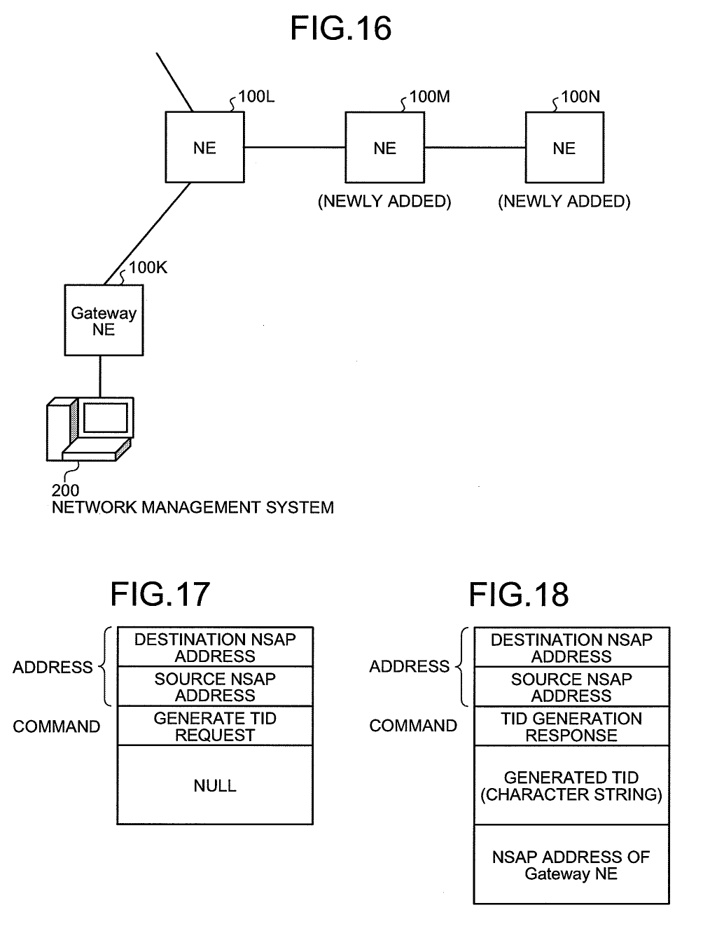

A structure of the network, which is used to explain the fourth embodiment, is shown in FIG. 16. Network elements 100K to 100N, which include a structure similar to the structure of the network element 100A shown in FIG. 2, are connected to form the network shown in FIG. 16. The network management system 200, which carries out the supervisory control of the entire network, is connected to the network element 100K.

In the network shown in FIG. 16, automatic allocation of the TID is explained by assuming that the network element 100M is newly connected to the network element 100L that is already connected to the network. Further, it is prior assumed that each network element is connected by using the optical fiber cables such as OC-3 or the fiber cables such as EC-1 and establishment of the DCC line is completed.

It is assumed that “FUJITSU” is allocated to the network elements 100M and 100N as the initial TID at the time of manufacturing and that “KAWASAKI” is allocated as the TID to the network element 100L that is already connected to the network.

After establishment of the DCC line, for requesting the adjacent network element 100L to allocate the TID, the TID generator 10 of the network element 100M generates a generate TID request that is shown in FIG. 17, and transmits the generate TID request to the adjacent network element 100L via the OSI protocol terminal 8, the multiplexer/demultiplexer 6, the transmitters 5, the DCC MUX 2, and the interfaces 1.

The network element 100L receives the generate TID request in the OSI protocol terminal 8, and notifies the TID generator 10. The TID generator 10 extracts the TID of the network element 100L itself from the management-data storage unit 11, and adds a number after the TID to generate a new TID. For example, if the TID generator 10 of the network element 100L is requested to generate the TID for a second time, a TID such as “KAWASAKI-2” is generated.

The TID of the network element 100L, which is already connected to the network, is likely to be unique and by further adding a number to the TID, a unique TID can be easily generated. The character string, which is added to the already existing TID, need not be a serial number if the character string does not overlap with other character strings. For example, a character string that indicates a current time or a random number can also be used.

The TID generator 10 of the network element 100L embeds the generated new TID and the NSAP address, prior stored in the management-data storage unit 11, of the gateway NE (the network element 100K in the example shown in FIG. 16) to generate a TID generation response that is shown in FIG. 18. The TID generation response is transmitted to the network element 100M via the OSI protocol terminal 8, the multiplexer/demultiplexer.6, the transmitters 5, the DCC MUX 2, and the interfaces 1.

The network element 100M receives the TID generation response in the OSI protocol terminal 8. The TID generator 10 stores the TID in the management-data storage unit 11 for setting the returned TID as the TID of the network element 100M itself. Further, for notifying the returned TID to the network management system 200 as the TID of the network element 100M itself, the network element 100M uses the NSAP address, stored in the TID generation response, of the gateway NE as the destination address and transmits a set TID request.

The set TID request which is transmitted by the network element 100M is transmitted to the network element 100K via the network element 100L. The set TID request is received in the OSI protocol terminal 8 of the network element 100K and is notified to the network management system 200 that is connected to the network element 100K. The TID processor 17 recognizes the TID of the newly added network element 100K and stores the TID in the management-data storage unit 18.

TID setting of the network element 100M is completed by using the string of the operation mentioned earlier. A similar operation is carried out between the network element 100M that has already received the unique TID and the network element 100N that is still allocated the initial TID. Due to this, the network element 100N is also allocated a unique TID. The TID which is allocated to the network element 100N is obtained by adding new characters after the TID of the network element 100M. For example, the TID of the network element 100N is a character string such as “KAWASAKI-2-1”.

In the fourth embodiment, a network element, which is adjacent to the newly added network element, adds a serial number to the TID of the network element itself to generate a unique TID and notifies the generated TID to the newly added network element. Thus, the unique TID can be automatically allocated to the newly added network element.

According to one aspect of the present invention, when adding a new network element, a network administrator does not need to directly connect a terminal to the network element and carry out an onsite setting operation. Thus, a burden on the network administrator is reduced and occurrence of setting errors due to a manual setting can be avoided.

According to another aspect of the present invention, a high-speed and highly reliable supervisory control line can be set without carrying out the manual setting.

According to still another aspect of the present invention, a unique ID can be automatically allocated to the newly added network element and the newly added network element can be remotely controlled by specifying the ID from a network management system.

According to still another aspect of the present invention, the unique ID can be automatically allocated to the newly added network element and the newly added network element can be remotely controlled by specifying the ID from the network management system.

According to still another aspect of the present invention, the unique ID can be automatically allocated to the newly added network element and the newly added network element can be remotely controlled by specifying the ID from the network management system.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method for automatically setting a supervisory control line between a first network element and a second network element, the method comprising:
transmitting a link establish request by the first network element to the second network element;
deciding, by the second network element that receives the link establish request, a channel for establishing the supervisory control line between the second network element and the first network element;
transmitting a link establish response to the first network element via the channel; and
allocating, by the first network element that receives the link establish response, the channel that transmits the link establish request as a channel for establishing the supervisory control line between the first network element and the second network element.

2. The method according to claim 1, further comprising:
mutual transmitting by the first network element and the second network element, after the supervisory control line is established, of identification numbers of the respective network elements to each other; and
setting, upon the identification number, retrieved at the mutual transmitting, of an opposite network element being the same as an identification number that is retrieved via another supervisory control line that is already established, such that the supervisory control lines in which the same identification number is retrieved are combined and used.

3. The method according to claim 1, wherein the first network element or the second network element is a new network element that is newly added to a network, further comprising:
generating, after the supervisory control line is established, based on a unique number that is prior allocated to the new network element itself, an identification by the new network element for identifying the new network element itself; and
notifying the identification generated at the generating to a network management system that entirely controls the network.

4. The method according to claim 1, wherein the first network element or the second network element is a new network element that is newly added to a network, further comprising:
generating, after the supervisory control line is established, an identification for identifying the new network element, by a network management system that entirely controls the network, such that the generated identification does not overlap with identifications of all the network elements that are stored by the network management system itself; and
notifying the identification generated at the generating to the new network element.

5. The method according to claim 1, wherein the first network element or the second network element is a new network element that is newly added to a network, further comprising:
adding, after the supervisory control line is established, a unique character string by an opposite network element of the new network element to an identification for identifying the opposite network element itself, thereby generating an identification for identifying the new network element; and
notifying the identification generated at the adding to the new network element.

6. The method according to claim 1, wherein the supervisory control line is a data communication channel line that is realized by using an overhead portion of synchronous optical network/synchronous digital hierarchy signals.

7. The method according to claim 3, wherein the supervisory control line is a data communication channel line that is realized by using an overhead portion of synchronous optical network/synchronous digital hierarchy signals, and the unique number is a portion of a network service access point address of the new network element itself.
